(19) United States
(12) Patent Application Publication
(10) Pub. No.: US 2009/0167747 A1
(43) Pub. Date: Jul. 2, 2009

(54) TFT-LCD DRIVER CIRCUIT AND LCD DEVICES

(75) Inventors: Duo GONG, Shenzhen (CN); ZhiQiang HE, Shenzhen (CN); Yun YANG, Shenzhen (CN); Wei FENG, Shenzhen (CN)

Correspondence Address: GREENBERG TRAURIG, LLP (SV);IP DOCKETING, 2450 COLORADO AVENUE, SUITE 400E, SANTA MONICA, CA, 90404, US

(73) Assignee: BYD COMPANY LIMITED, Shenzhen (CN)

(21) Appl. No.: 12/325,331

(22) Filed: Dec. 1, 2008

(30) Foreign Application Priority Data
Dec. 27, 2007 (CN) 200710305838.1

(51) Int. Cl. G09G 5/00

(52) U.S. Cl. 345/212

(57) ABSTRACT

Thin film transistor liquid crystal display (TFT-LCD) driver circuit having a source drive buffer with an operational power amplifier having two differential amplifiers capable of alternating operation according to timing and bias voltage signals. The differential amplifiers are further capable of functioning as a voltage follower by inputting and outputting voltage signals from a digital to analog converter for charging display points. The TFT-LCD driver circuit may also be incorporated within a LCD device.

### CROSS-REFERENCE TO PRIOR APPLICATIONS

This application claims priority to Chinese Patent Application No. 200710305838.1, filed Dec. 27, 2007.

### FIELD OF THE INVENTION

The present invention relates to liquid crystal displays, more specifically, to thin film transistor liquid crystal display (TFT-LCD) driver circuit and liquid crystal display devices.

### BACKGROUND

Current thin film transistor liquid crystal display (TFT-LCD) technologies have been trending toward higher levels of integration, higher resolution and multi-grayscale capabilities. As such, the TFT-LCD driver circuit device area and power consumption have increased accordingly leading to higher manufacturing costs. In a traditional TFT-LCD driver circuit, the source drive buffer or latch of the source drive chip occupies a large footprint and consumes a considerable amount of power. Thus, chip designers are starting to look into ways of going about reducing the footprint and/or power consumption of the source drive buffer or latch on the source drive chip.

Accordingly, there is a need for an improved TFT-LCD driver circuit and corresponding LCD devices.

### SUMMARY

Accordingly, a first embodiment discloses a thin-film transistor liquid crystal display (TFT-LCD) driver circuit comprising: a gate driver adaptable to manipulate the TFT; a generator capable of providing grayscale voltage for display points; a timing circuit configured to provide timing signals; a bias circuit configured to provide bias voltage signals; and a source driver operable to charge the display points according to the grayscale voltage, wherein the source driver includes: a source drive latch configured to store data for the display points, the stored data capable of being decoded and converted by a digital to analog converter (DAC) to provide the grayscale voltage that need to be generated and provided to each display point; and a source drive buffer having an operational power amplifier (OPA), the OPA having first and second differential amplifiers, the differential amplifiers capable of alternating operation according to the timing and bias voltage signals, wherein each differential amplifier, by voltage follower mechanism, is capable of inputting and outputting voltage signals from the DAC for charging the display points.

The source drive buffer further includes a CMOS transmission gate in parallel with the OPA, wherein under control of the timing signals and while the OPA is inactive, the CMOS transmission gate is capable of adjusting the voltage output of the OPA using output signals from the DAC.

The first differential amplifier includes: a first differential circuit having two N-channel metal oxide semiconductor (NMOS), wherein the gate of the first NMOS is coupled to the output of the DAC and the gate of the second NMOS is coupled to the output of the OPA; a first current mirror being a loader of the first differential circuit; an end of current source; an output level which includes a NMOS and a PMOS, the gate of the NMOS and the end of current source controlled by the bias voltage signals, the gate of the PMOS coupled to the output of the first current mirror; and a power down PMOS operable to turning on and off the OPA by timing signals.

The second differential amplifier includes: a second differential circuit having two P-channel metal oxide semiconductor (PMOS), wherein the gate of the first PMOS is coupled to the output of the DAC while the gate of the second PMOS is coupled to the output of the OPA; a second current mirror being a loader of the second differential circuit; an end of current source; an output level which includes a PMOS and a NMOS, the gate of the PMOS and the end of current source controlled by the bias voltage signals, the gate of the NMOS coupled to the output of the second current mirror; and a power down NMOS which is applied for turning on and off OPA by timing signals.

In this embodiment during sub-threshold zone the threshold voltage of the OPA is higher than the bias voltage generated by the bias voltage signals.

In other embodiments, a liquid crystal display (LCD) device can be manufactured having a thin-film transistor (TFT) panel and using the TFT-LCD driver circuit as described in the previously disclosed embodiments.

Other variations, embodiments and features of the present invention will become evident from the following detailed description, drawings and claims.

### BRIEF DESCRIPTION OF THE DRAWINGS

FIG. 1 illustrates a thin film transistor (TFT) panel and corresponding circuit diagram;

FIG. 2 illustrates a TFT liquid-crystal display (TFT-LCD) driver circuit diagram according to a first embodiment;

FIG. 3 illustrates the relationship between input and output signals of an operational power amplifier (OPA) of a source drive buffer of FIG. 2;

FIG. 4 illustrates the circuit diagram of the OPA;

FIG. 5 illustrates a circuit diagram of a complementary metal oxide semiconductor (CMOS) transmission gate of the source drive buffer;

FIG. 6 illustrates PBIASL and NBIASL bias voltage control circuits of the TFT-LCD driver circuit;

FIG. 7 illustrates wave diagrams of the PBIASL and NBIASL bias voltage circuits of the TFT-LCD driver circuit;

FIG. 8 illustrates wave diagrams of SWITCH, SWITCH_N, and other timing switches of the source driver; and

FIG. 9 illustrates wave diagrams of the source drive buffer at various stages.

### DETAILED DESCRIPTION

It will be appreciated by those of ordinary skill in the art that the invention can be embodied in other specific forms without departing from the spirit or essential character thereof. The presently disclosed embodiments are therefore considered in all respects to be illustrative and not restrictive.

The source drive buffer of the TFT-LCD driver circuit of the presently disclosed embodiments can be formed with two basic differential amplifiers and a complementary metal oxide semiconductor (CMOS) transmission gate. The two differential amplifiers can be activated or controlled by timing signals, transmitted through the CMOS transmission gate for manipulating output voltage, and for charging pixel lines to the required voltage level until scanning is completed.

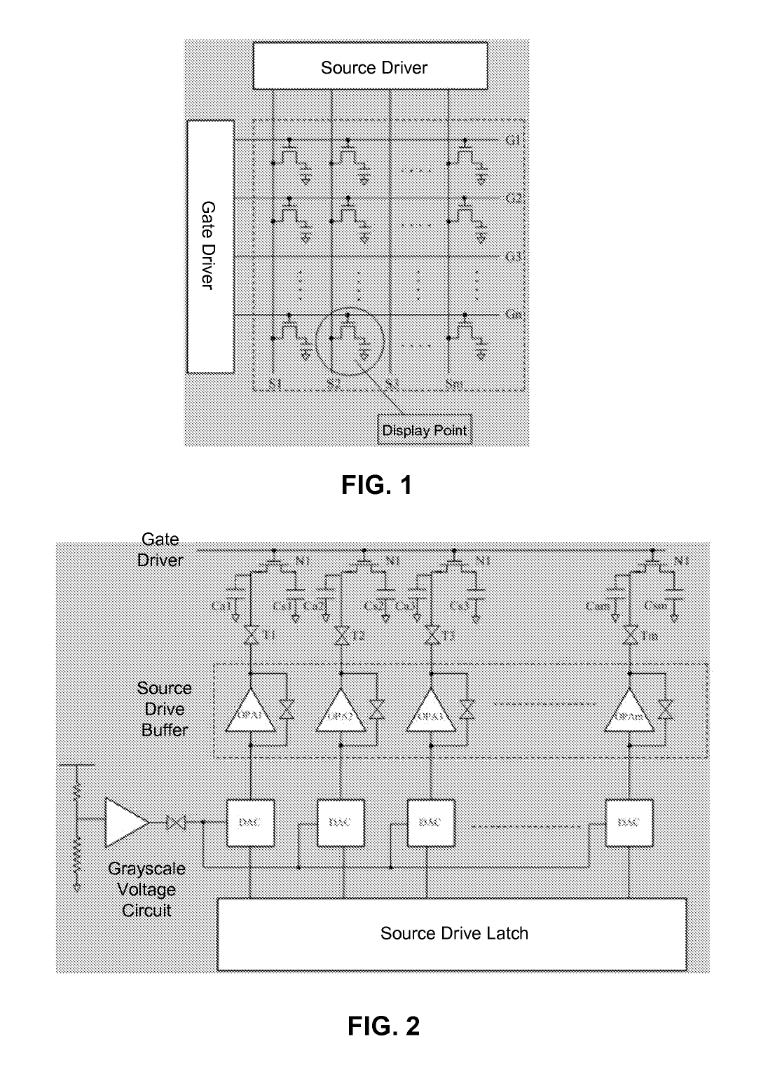

FIG. 1 illustrates a thin film transistor (TFT) panel and corresponding circuit diagram. The panel provides a plurality of points forming an n×m matrix with n rows (G1, G2, G3, . . . , Gn) and m columns (S1, S2, S3, . . . ,Sm), wherein each intersecting point represents a twisted nematic liquid crystal display (TN-LCD) point having a TFT and upper and lower conductive glasses forming a parallel plate capacitor (not shown) and a storage capacitor, the parallel plate capacitor and storage capacitor having parallel coupling. If a color filter has three basic colors, a basic pixel display unit needs to be able to display such points corresponding to red, green and blue, the three basic primary colors. At a specific time, the gate driver sends out a pulse signaling a line of TFT's to open. At the same time the source driver charges the line to the necessary voltage. When the line has been fully charged, the gate driver signals the line of TFT's to close and opens the next line of TFT's, and the charging process continues.

FIG. 2 illustrates a circuit diagram of a TFT-LCD driver circuit according to a first embodiment. The TFT-LCD driver circuit includes gate and source drivers, a grayscale voltage circuit with timing circuit generator (not shown), and a power generator bias circuit (not shown). As shown, a line has a total of N1 to Nm number of TFT's where each TFT can be opened or closed by a drive pulse sent by the gate driver, m number of TFT sources being connected to corresponding source drive outputs, and m number of TFT drains coupled to corresponding drain connection storage capacitors Cs1-Csm. Before scanning begins, the gate driver sends out a pulse control opening all the TFT's of the line. At the same time, latch data stored within the source driver can be decoded and converted by a digital to analog converter (DAC) to provide the grayscale voltage that need to be generated and provided to each display point, the grayscale voltage being transmitted through the source drive buffer and corresponding transmission gates T1-Tm, charging the electrode of each display point. The driver of the LCD panel, as shown in FIG. 2, includes m number of source drive buffer (in dashed outline) corresponding to m number of scanning lines and display points, each source drive buffer having an operational power amplifier (OPA).

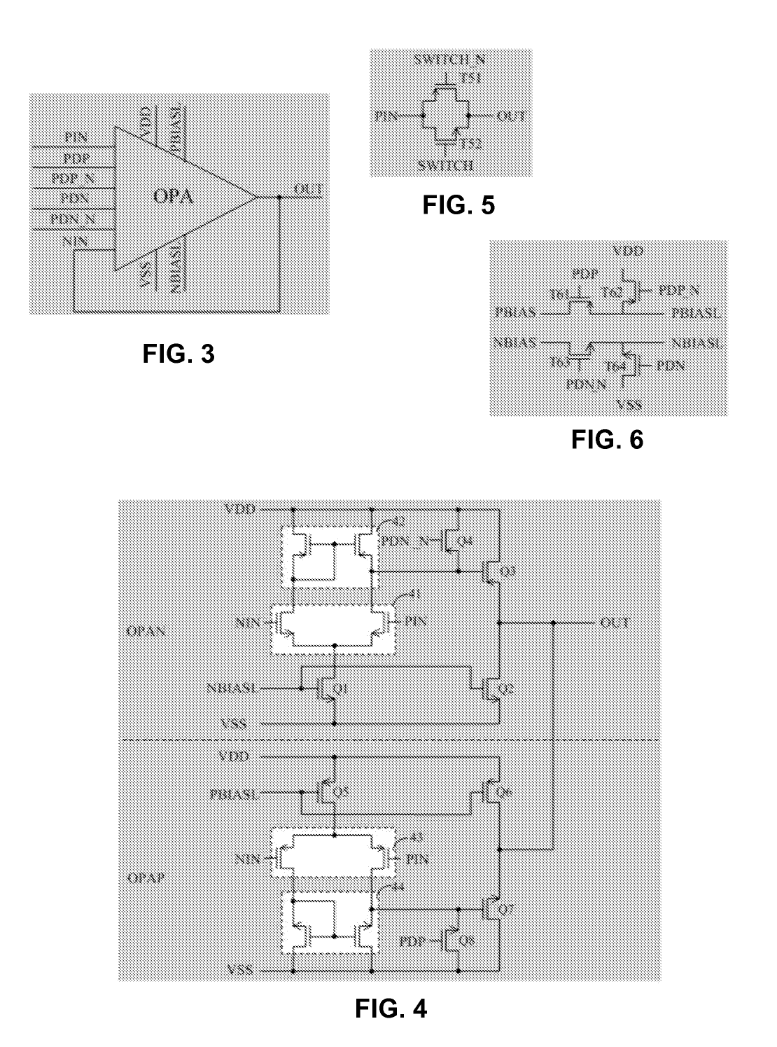

FIG. 3 illustrates the relationship between input and output signals of the OPA of the source drive buffer. Specifically, the OPA receives the corresponding voltage signal PIN from the DAC, together with timing signals PDP, PDP_N, PDN, PDN_N and bias voltage signals PBIASL and NBIASL, the voltage signal PIN being cached and transferred through corresponding T1-Tm transmission gates for charging corresponding display electrodes. The output side OUT of the OPA can be shorted with feedback NIN causing the output voltage to feedback to the OPA and terminate with the NIN, the entire operation of the OPA being similar to that of a voltage follower. During this process, various timing signals are produced from the TFT-LCD driver circuit and accompanying timing circuits.

FIG. 4 is a circuit diagram of the OPA having a first differential amplifier (OPAN) and a second differential amplifier (OPAP), the two differential amplifiers OPAN, OPAP controlled by timing signals for alternating operations. The OPAN includes a first differential circuit 41 having two N-channel metal oxide semiconductor (NMOS) in the input stage, the gates of the NMOS being coupled to the output voltage source PIN of the DAC and the output terminal OUT of the source drive buffer. The source of the two NMOS channels can be coupled to form a coupled source, which passes through a first switch Q1 and connects with the access control drive circuit zero potential VSS. From the bias at the first switch Q1, the drain of the first differential circuit 41 passes through a first current mirror source 42 and is coupled to the power port VDD of the drive circuit. With the first current mirror source 42 as the load, the OPAN is mainly able to deliver enhanced output impedance and higher gain. The output level of the OPAN, which is a simple co-source structure, provides enhanced waveform signals with second and third switches Q2, Q3 being coupled in series, the series coupling being the output terminal OUT of the OPA. The gates of the second switch Q2 and the first switch Q1 are coupled in series with the turn on being controlled by the bias voltage control signal NBIASL. The gate of the third switch Q3 is coupled to the source of the first current mirror source 42, and also passes through a fourth switch Q4 and connects to the power port VDD of the drive circuit. The gate of the fourth switch Q4 can be turned on or controlled by timing signals from PDN_N, with the main role of the fourth switch Q4 being to control and ensure that the OPAN is working properly.

Similarly, the input stage of the OPAP includes two P-channel metal oxide semiconductor (PMOS) forming a second differential circuit 43, the gates of the two PMOS being coupled to the output source PIN of the DAC and the output terminal OUT of the source drive buffer. The source of the two PMOS are coupled together to form a coupled source, which passes through a fifth switch Q5 and connects with the power port VDD of the drive circuit. From the bias at the fifth switch Q5, the drain of the second differential circuit 43 passes through a second current mirror source 44 and can be coupled to the access control drive circuit zero potential VSS. With the second current mirror source 44 as the load, the OPAP is mainly able to deliver enhanced output impedance and higher gain. The output of the OPAP, which is a simple co-source structure, includes sixth and seventh switches Q6, Q7 being coupled in series, the series part being the output terminal OUT of the OPA. The gates of the sixth switch Q6 and the fifth switch Q5 are coupled in series, the turn on being controlled by the bias voltage control signal PBIASL. The gate of the seventh switch Q7 is coupled to the source of the second current mirror source 44, and also passes through an eighth switch Q8 and connects to the access control drive circuit zero potential VSS. The gate of the sixth switch Q8 can be turned on and controlled by timing signals PDP, the main role of the eighth switch Q8 being to control and ensure the OPAP is working properly.

As shown in FIG. 4, the two differential amplifiers OPAN and OPAP of the operational power amplifier OPA are controlled by timing signals, with the OPAN being effective in pulling up or raising voltage levels and the OPAP being effective in pulling down or reducing voltage levels. When scanning is taking place, there is only one contribution from the OPA, which in turn causes variations between the output waveform and actual input waveform of the buffer. Accordingly, in one embodiment, each of the two ends of the OPA within the buffer can be coupled to a parallel CMOS transmission gate as shown in FIG. 5, which enhances or alters the output waveform. The source of the PMOS T51 and the drain of the NMOS T52 can be coupled to form an input stage CMOS transmission gate, while the drain of the PMOS T51 and the source of the NMOS T52 can be coupled to form an output stage CMOS transmission gate. Because the sources and drains of the NMOS and PMOS can be manipulated, other coupling structures may be utilized. For example, drain to drain coupling or source to source coupling of two NMOS or PMOS may be incorporated. The PMOS T51 and the NMOS T52 can be turned on or controlled by a pair of complementary timing signals SWITCH and SWITCH_N. The input stage of the CMOS transmission gate can be coupled to the input terminal PIN of the OPA while the output stage of the CMOS transmission gate can be connected to the output terminal OUT of the OPA.

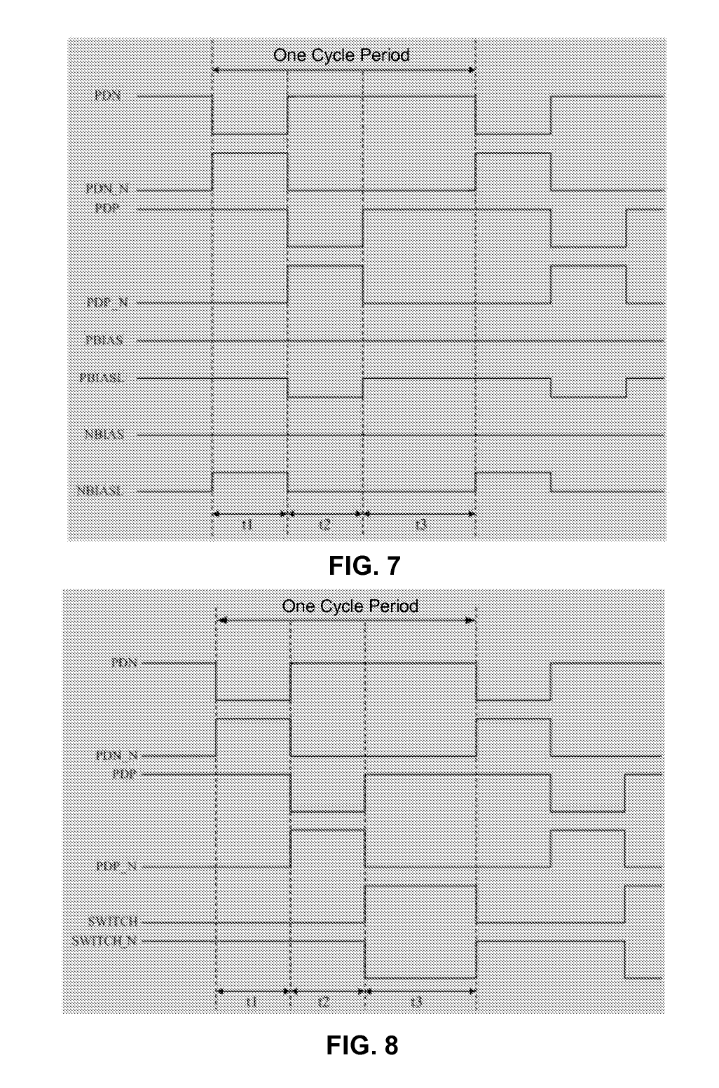

FIGS. 6 and 7 illustrate circuit and wave diagrams, respectively, of the PBIASL and NBIASL bias voltage control circuitry. The offset voltage signals from the bias voltage control circuits PBIASL and NBIASL serve as the voltage module for the TFT-LCD driver circuit, and also provide the bias voltage for the source drive buffer. The offset voltage signals and bias voltage signals from the bias voltage control circuits PBIASL and NBIASL may also serve as the voltage module for other electrical circuits within the TFT-LCD driver circuit.

As shown in FIGS. 6 and 7, when gate scanning occurs during t1 and t3 periods, PDP maintains high voltage levels while PDP_N maintains low voltage levels. Switch T62 opens, switch T61 closes, and the bias control circuitry PBIASL is pulled up or elevated by the system to maintain high voltage levels VDD. During period t2, PDP maintains a low voltage level while PDP_N maintains a high voltage level. Switch T61 opens, switch T62 closes, and PBIAS directly outputs to PBIASL. Similarly, during period t1, PDN maintains low voltage level while PDN_N maintains high voltage level. Switch T63 opens, switch T64 closes, and NBIAS directly outputs to NBIASL. During t2 and t3 periods, PDN maintains high voltage levels while PDN_N maintains low voltage levels. Switch T64 opens, switch T63 closes, and bias control circuitry NBIASL is pulled down or elevated by the system to maintain low voltage levels VSS. The waveforms of the bias voltage control circuitry PBIASL and NBIASL are shown in FIG. 7, while the waveforms of timing signals SWITCH and SWITCH_N and other timing circuitry are shown in FIG. 8.

As shown in FIGS. 2-8, the working principles of the disclosed source drive buffer embodiments during t1+t2+t3 scan periods can be described as follows. The data as stored in the source drive latch, after having been decoded and converted by the DAC, select the appropriate level of grayscale voltage to generate and accordingly generate the required voltage output. During period t1, the bias voltage signal NBIASL controls turn on of the first switch Q1 and the second switch Q2 initiating functions of the first differential circuit 41 and the first current mirror source 42. Because the PDN_N maintains a high voltage level, the fourth switch Q4 cuts off and OPAN is able to function normally. The cached voltage as generated by the grayscale voltage generator can be transmitted, while the bias voltage control circuitry PBIASL maintains a high voltage level. The fifth switch Q5 cuts off and the PDP, maintaining a high voltage level, is directed through the eighth switch Q8 thereby pulling down or lowering the gate of the seventh switch Q7 to low voltage level VSS. The OPAP switches off during period t1 while the OPAN is in operation. During period t2, the OPAP is active whereby its function is the exact opposite to that described during period t1, and thus will not be elaborated further herein. Because the entire OPA functions similar to that of a voltage follower, during t1 and t2 periods, the voltage and the subsequent following operates to ensure that the output level OUT and input level PIN are similar. It should be appreciated by one skilled in the art that the previously described scenario may be reversed such that the OPAP is in operation during period t1 while the OPAN is in operation during period t2. The operational functions of the amplifiers and corresponding grayscale voltages are similar to those described above and thus will not be elaborated further herein.

During period t3, the bias voltage control circuitry NBIASL and PBIASL cannot simultaneously turn on both switches Q1 and Q5. Both first and second differential amplifiers OPAN and OPAP must switch off. During this time, timing signals SWITCH and SWITCH_N control and turn on the CMOS transmission gate thereby shorting the input and output stages of the source drive buffer. The voltage from the DAC sends out the decoded or repaired cached data from the source buffer driver, which approaches or is close to an ideal value.

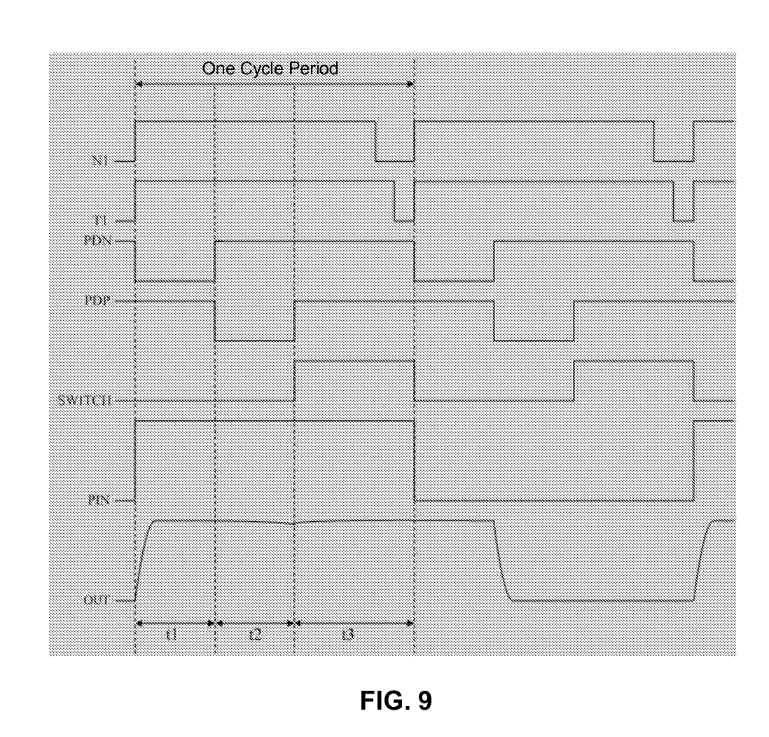

FIG. 9 illustrates wave diagrams of the source drive buffer at various signals toward output voltage generated by storing and cycling the grayscale voltage circuit. Specifically, N1 represents the output drive pulse waveform of the gate driver, T1 represents the waveform of the transmission gate, PIN represents the output waveform of the DAC, and OUT represents the output waveform of the source drive buffer.

In the embodiments described above, the first differential amplifier OPAN can effectively pull up or raise voltages such that a low voltage level can be elevated to a high voltage level while in operation, while the second differential amplifier OPAP can effectively pull down or reduce voltages such that a high voltage level can be lowered to a low voltage level while in operation. During the scanning process, only one differential amplifier is contributing to the system thereby causing variations between the output waveform and the actual input waveform of the buffer. After grayscale voltage adjustments, these variations will not influence the on-screen display because the voltage stored on the storage capacitor Cs of the LCD panel will, prior to the TFT, lower the N1 from high voltage to low voltage with the output cache being at or close to an ideal value.

The presently disclosed embodiments, in order to reduce computing static and power consumption of power amplifiers in the sub-threshold zone, have bias voltage control signals PBIAS and NBIAS voltage values being slightly lower than the threshold voltage. Additionally, to expand the zone of the common-mode input, mixed use NMOS differential pair (first differential amplifier) and PMOS differential pair (second differential amplifier) may be incorporated as a two-tier operational power amplifier. Through timing controls, time sharing of the two operational power amplifiers can be realized effectively raising the range of input voltage, and because of the reduced complexity of the source drive buffer, circuitry dimensions can be reduced and less area or die size would be required. Furthermore, with two differential operational power amplifiers working separately, power consumption can also be reduced.

Although the invention has been described in detail with reference to several embodiments, additional variations and modifications exist within the scope and spirit of the invention as described and defined in the following claims.

What is claimed is:

1. A thin-film transistor liquid crystal display (TFT-LCD) driver circuit comprising:
a gate driver adaptable to manipulate the TFT;
a generator capable of providing grayscale voltage for display points;
a timing circuit configured to provide timing signals;
a bias circuit configured to provide bias voltage signals; and
a source driver operable to charge the display points according to the grayscale voltage, wherein the source driver includes:
a source drive latch configured to store data for the display points, the stored data capable of being decoded and converted by a digital to analog converter (DAC) to provide the grayscale voltage that need to be generated and provided to each display point; and
a source drive buffer having an operational power amplifier (OPA), the OPA having first and second differential amplifiers, the differential amplifiers capable of alternating operation according to the timing and bias voltage signals, wherein each differential amplifier, by voltage follower mechanism, is capable of inputting and outputting voltage signals from the DAC for charging the display points.

2. The circuit of claim 1, wherein the source drive buffer further includes a CMOS transmission gate in parallel with the OPA, wherein under control of the timing signals and while the OPA is inactive, the CMOS transmission gate is capable of adjusting the voltage output of the OPA using output signals from the DAC.

3. The circuit of claim 1, wherein the first differential amplifier includes:
a first differential circuit having two N-channel metal oxide semiconductor (NMOS), wherein the gate of the first NMOS is coupled to the output of the DAC and the gate of the second NMOS is coupled to the output of the OPA;
a first current mirror being a loader of the first differential circuit;
an end of current source;
an output level which includes a NMOS and a PMOS, the gate of the NMOS and the end of current source controlled by the bias voltage signals, the gate of the PMOS coupled to the output of the first current mirror; and
a power down PMOS operable to turning on and off the OPA by timing signals.

4. The circuit of claim 1, wherein the second differential amplifier includes:
a second differential circuit having two P-channel metal oxide semiconductor (PMOS), wherein the gate of the first PMOS is coupled to the output of the DAC while the gate of the second PMOS is coupled to the output of the OPA;
a second current mirror being a loader of the second differential circuit;
an end of current source;
an output level which includes a PMOS and a NMOS, the gate of the PMOS and the end of current source controlled by the bias voltage signals, the gate of the NMOS coupled to the output of the second current mirror; and
a power down NMOS which is applied for turning on and off OPA by timing signals.

5. The circuit of claim 1, wherein during sub-threshold zone the threshold voltage of the OPA is higher than the bias voltage generated by the bias voltage signals.

6. A liquid crystal display (LCD) device comprising:
a thin-film transistor (TFT) panel;
a TFT-LCD driver circuit comprising:
a gate driver adaptable to manipulate the TFT;
a generator capable of providing grayscale voltage for display points;
a timing circuit configured to provide timing signals;
a bias circuit configured to provide bias voltage signals; and
a source driver operable to charge the display points according to the grayscale voltage, wherein the source driver includes:
a source drive latch configured to store data for the display points, the stored data capable of being decoded and converted by a digital to analog converter (DAC) to provide the grayscale voltage that need to be generated and provided to each display point; and
a source drive buffer having an operational power amplifier (OPA), the OPA having first and second differential amplifiers, the differential amplifiers capable of alternating operation according to the timing and bias voltage signals, wherein each differential amplifier, by voltage follower mechanism, is capable of inputting and outputting voltage signals from the DAC for charging the display points.

7. The device of claim 6, wherein the source drive buffer further includes a CMOS transmission gate in parallel with the OPA, wherein under control of the timing signals and while the OPA is inactive, the CMOS transmission gate is capable of adjusting the voltage output of the OPA using output signals from the DAC.

8. The device of claim 6, wherein the first differential amplifier includes:
a first differential circuit having two N-channel metal oxide semiconductor (NMOS), wherein the gate of the first NMOS is coupled to the output of the DAC and the gate of the second NMOS is coupled to the output of the OPA;
a first current mirror being a loader of the first differential circuit;
an end of current source;
an output level which includes a NMOS and a PMOS, the gate of the NMOS and the end of current source controlled by the bias voltage signals, the gate of the PMOS coupled to the output of the first current mirror; and
a power down PMOS operable to turning on and off the OPA by timing signals.

9. The device of claim 6, wherein the second differential amplifier includes:
a second differential circuit having two P-channel metal oxide semiconductor (PMOS), wherein the gate of the first PMOS is coupled to the output of the DAC while the gate of the second PMOS is coupled to the output of the OPA;
a second current mirror being a loader of the second differential circuit;
an end of current source;
an output level which includes a PMOS and a NMOS, the gate of the PMOS and the end of current source controlled by the bias voltage signals, the gate of the NMOS coupled to the output of the second current mirror; and
a power down NMOS which is applied for turning on and off OPA by timing signals.

10. The device of claim 6, wherein during sub-threshold zone the threshold voltage of the OPA is higher than the bias voltage generated by the bias voltage signals.

11. A thin-film transistor liquid crystal display (TFT-LCD) driver circuit comprising:
a gate driver adaptable to manipulate the TFT;
a generator capable of providing grayscale voltage for display points;
a timing circuit configured to provide timing signals;
a bias circuit configured to provide bias voltage signals; and
a source driver operable to charge the display points according to the grayscale voltage, wherein the source driver includes:
a source drive latch configured to store data for the display points, the stored data capable of being decoded and converted by a digital to analog converter (DAC) to provide the grayscale voltage that need to be generated and provided to each display point; and
a source drive buffer having an operational power amplifier (OPA), the OPA having:
a first differential amplifier including:
a first differential circuit having two N-channel metal oxide semiconductor (NMOS), wherein the gate of the first NMOS is coupled to the output of the DAC and the gate of the second NMOS is coupled to the output of the OPA;
a first current mirror being a loader of the first differential circuit;
a first end of current source;
an output level which includes a third NMOS and a third PMOS, the gate of the third NMOS and the first end of current source controlled by the bias voltage signals, the gate of the third PMOS coupled to the output of the first current mirror;
a power down PMOS operable to turning on and off the OPA by timing signals;
a second differential amplifier including:
a second differential circuit having two P-channel metal oxide semiconductor (PMOS), wherein the gate of the first PMOS is coupled to the output of the DAC while the gate of the second PMOS is coupled to the output of the OPA;
a second current mirror being a loader of the second differential circuit;
a second end of current source;
an output level which includes a fourth PMOS and a fourth NMOS, the gate of the fourth PMOS and the end of current source controlled by the bias voltage signals, the gate of the fourth NMOS coupled to the output of the second current mirror;
a power down NMOS which is applied for turning on and off OPA by timing signals; and
wherein the two differential amplifiers are capable of alternating operation according to the timing and bias voltage signals, wherein each differential amplifier, by voltage follower mechanism, is capable of inputting and outputting voltage signals from the DAC for charging the display points.

12. The circuit of claim 11, wherein the source drive buffer further includes a CMOS transmission gate in parallel with the OPA, wherein under control of the timing signals and while the OPA is inactive, the CMOS transmission gate is capable of adjusting the voltage output of the OPA using output signals from the DAC.

13. The circuit of claim 11, wherein during sub-threshold zone the threshold voltage of the OPA is higher than the bias voltage generated by the bias voltage signals.
